(19) United States
(12) Patent Application Publication
(10) Pub. No.: US 2025/0367671 A1
(43) Pub. Date: Dec. 4, 2025

(54) NEST REMOVAL DEVICE, NEST HANDLING SYSTEM AND METHOD FOR HANDLING A NEST WITH A TUB

(71) Applicant: Körber Pharma Inspection GmbH, Markt Schwaben (DE)

(72) Inventors: Zeno Bauer, Markt Schwaben (DE); Andreas Mayr, Markt Schwaben (DE); Martin Haberstetter, Markt Schwaben (DE); Herbert Grindinger, Markt Schwaben (DE)

(21) Appl. No.: 19/223,378

(22) Filed: May 30, 2025

(30) Foreign Application Priority Data
May 31, 2024 (DE) 10 2024 115 236.2

(51) Int. Cl. B01L 9/06

(52) U.S. Cl. CPC B01L 9/06; B01L 2200/025; B01L 2200/185; B01L 2300/0663

(57) ABSTRACT

A nest removal device for removing a nest from a tub is provided. The nest removal device includes a feed section configured to convey at least one tub, in which a nest is accommodated, in a conveying direction, a removal section configured to position the at least one tub in a removal position, a removal device configured to remove the nest from the at least one tub, which is in the removal position, and a discharge section configured to transport the at least one tub away. The removal section comprises at least a first stopper for positioning the at least one tub in the removal position. Furthermore, a handling system for handling a tub and a nest and a method for handling a nest and a tub are provided.

### BACKGROUND OF THE INVENTION

The present disclosure relates to a nest removal device for removing a nest from a tub, a nest handling system for handling a tub and a nest, and a method for handling a nest and a tub.

In order to transport pharmaceutical products, in particular vials, syringes, cartridges (cylinder ampoules) or vessels, so-called tubs are known in the prior art, in which nests can be accommodated and held. The tubs have a tub-like design so that nests can be accommodated in such a way that pharmaceutical products held in the nests are held securely. The nests optionally have a grid-like structure so that each product has a holder and the products are prevented from coming into contact with each other.

During a manufacturing process of pharmaceutical products, it may be necessary to remove a nest from a tub. It may also be necessary to remove the pharmaceutical products from the nests. Due to the complexity of the design of a tub and a nest, such handling of the same can only be realized very slowly. In particular, due to the fragility and other properties of the pharmaceutical products, handling is often carried out manually or only slowly automated in the prior art.

It is therefore an object of the present disclosure to provide a device and a method with which the handling of nests and tubs can be accelerated.

### SUMMARY OF THE INVENTION

According to one aspect of the present disclosure, a nest removal device for removing a nest from a tub is provided. The nest removal device may comprise a feed section designed to convey at least one tub, in which a nest is accommodated, in a conveying direction. The nest removal device may comprise a removal section designed to position the at least one tub in a removal position. The nest removal device may comprise a removal device designed to remove the nest from the tub which is in the removal position. The nest removal device may comprise a discharge section designed to remove the tub. The removal section may comprise at least a first stopper to position the tub in the removal position.

Compared to the known prior art, the subject matter of the present disclosure has the advantage that an increased throughput of nests can be achieved. In other words, the nest removal device can be operated in a clocked manner so that the nests can be quickly removed from the tubs positioned in the removal position. In other words, the removal device does not have to adapt to a movement of the tub in order to remove the nest from it, but can remove the nest from a stationary tub (i.e. a tub in the removal position). This allows the removal device to work quickly and place the nest removed from the tub in a deposit position. The deposit position for the nests can, for example, be another transport device in which three nests are transported parallel to each other in a conveying direction or also in the first direction. In practice, the removal device can therefore remove a nest from a tub that is in the removal position and place it in the first deposit position. If the nest is arranged in the first deposit position, another tub may already have been brought into the removal position, so that the removal device can directly remove another nest from the tub and deposit it in a second deposit position. During this action, another tub is already arranged in the removal position, so that the removal device can directly remove the third nest from a tub that is in the removal position after depositing the second nest and deposit it at the third deposit position. It is advantageous that the first deposit position, the second deposit position and the third deposit position are located next to each other. Optionally, the deposit positions are parallel along the feed section. The stopper can ensure that a new tub with nest is ready in the correct position when the removal device has deposited a previously handled nest. This can significantly increase the throughput, as the removal device can remove the nests from stationary tubs and does not have to be moved parallel to the conveying direction of the tubs. In summary, the quantity of nests handled (and therefore of pharmaceutical products handled) can be increased without the risk of damage or errors occurring during operation.

The nest removal device may be a mechanical, physical device designed to remove a nest from a tub. Optionally, the nest removal device can be designed to provide the nests on a nest transportation means. The nest transportation means can be a belt conveyor that can transport at least three nests next to each other in a belt conveying direction. The belt conveying direction can be essentially orthogonal to the conveying direction. The nest transportation means can be arranged directly adjacent to the removal device. This can ensure that the nests can be satisfactorily transferred from the tubs to the nest transportation device. Optionally, the nest transportation conveying direction is essentially orthogonal to the conveying direction. This can provide a nest removal device that can have a significantly increased throughput of handled vessels. For example, the nest removal device can be designed to handle more than 600 pharmaceutical products per minute. Optionally, the nest removal device can handle approximately 1000 pharmaceutical products per minute. The pharmaceutical products can be vessels, syringes, syringe parts, vials, syringes, cartridges (cylinder ampoules) or the like.

The feed section can be a device designed to move a tub. Optionally, the feed section can move a large number of tubs. The tub to be moved can interact with the feed section in a force-fit and/or form-fit manner. This can provide a defined movement of the tub. The removal device can be a device that can remove a nest from a tub. The tub can stand still (i.e. not be conveyed) while the nest is being removed by the removal device. In this way, a particularly fast removal can be realized. Optionally, the removal device is a robot-like device that can handle a nest with all the vessels held in the nest. Optionally, the removal device can be designed to lift a nest out of a tub against the gravity direction. The removal device can be a suction gripping device that can hold and move the nest using a vacuum. For this purpose, the removal device can have a plurality of suction cups that can come into contact with a part of the nest in order to grip and/or hold it. For example, a nest may have a contact section (e.g. a circumferential collar) at which the removal device can contact the nest. Optionally, the removal device has eight suction cups. This allows a nest to be held particularly evenly. The removal device can comprise a moving section and a gripping section. The gripping section can comprise the gripping device. The gripping device can be a pneumatic or mechanical gripper. The movement device can be designed as a delta robot. This allows the removal device to displace a nest anywhere in the room. The removal device can be designed to remove a nest from a tub and then feed the nest to a nest transportation system. The nest transportation system can be a multi-channel nest transportation system, for example, which is designed to transport several nests next to each other. In other words, the nest can be removed from the tub by the removal device and transported away without the tub, so that the tub remains in the removal position without the nest. The empty tub can then be transported away from the removal position. Optionally, the gripping device comprises a vacuum distribution system that can be pressurized by a vacuum pump. Optionally, the removal device comprises only a single vacuum device. Optionally, the gripping device has a frame-like design. This saves weight and the gripping device can be better adapted to the nest to be gripped. Optionally, the gripping device of the removal device comprises a projection. The projection can be designed to position the removal device and a nest relative to each other in such a way that the removal device can grip the nest easily. The projection can therefore be designed as a centering aid. This can ensure that the removal device makes contact with the nest at the contact surface and that there is no leakage of vacuum air. Optionally, the projection has a tapered shape. Optionally, the protrusion is oriented in the gravity direction. This ensures that the gripping device makes contact with the nest to be removed at the appropriate contact points. This prevents incorrect contact between the nest and the removal device. The removal device can then deposit the gripped nest at any position in the room. As described above, the removal device optionally deposits the nest in a recess provided for this purpose in another belt conveyor. The discharge section can be designed to discharge an empty tub from the removal position. The tub can be discharged from the removal position in the same direction as it entered the removal position. This means that continuous operation can be achieved, allowing a higher throughput. The removal position can be a defined position in which the removal device can remove the nest from the tub. Optionally, the removal position is selected in such a way that an average distance between the removal position and all target positions (i.e. the deposit positions) at which the nests are to be deposited by the removal device is minimized. This can increase the efficiency of the overall system. The empty tubs can then be removed from the nest removal device via the discharge section. The stopper can, for example, be designed as a stop that fixes (i.e. holds) a tub with a nest to be handled in the removal position. In other words, the stopper can be designed to interrupt a movement of the tub in the conveying direction so that the tub is in the removal position. The stopper can be retracted into the travel path of the tub and thus prevent further transportation of the tub. The stopper can have a cylindrical section at its outer end (i.e. the end that comes into contact with the tub). This prevents damage to the tub due to contact with the stopper. The stopper can be actuated intermittently so that the tub is only stopped until the removal device has removed the nest from the tub. The stopper can then be designed to retract or fold away again to clear the way for the tub. This allows a large number of tubs to be processed one after the other, whereby each tub is only stopped by the stopper until the nest has been removed from the tub by the removal device. This can significantly increase the throughput of vessels held in nests.

Optionally, the discharge section has a buffer section that is designed to temporarily store at least one tub. In other words, the buffer section can be designed to temporarily store an empty tub. temporarily store in this context can mean that the transfer of at least one tub is delayed. This means that empty tubs can be provided at a certain frequency at a downstream end of the conveyor section. For example, the accelerated removal of the nests from the tubs may result in more empty tubs being made available (i.e. at the end of the discharge section) than can actually be handled by an element located downstream. It is therefore advantageous if a buffer section is interposed, which can buffer tubs accordingly. The buffer section can, for example, be a device that can remove tubs from the discharge section. Furthermore, a buffer section can temporarily store the removed tubs in a storage section and feed them directly back to the discharge section or another element at a feed section.

Optionally, the buffer section is designed to temporarily store at least one tub so that other tubs can pass through the buffer section. In other words, the buffer section can be realized by a system connected in parallel so that the discharge section can transport tubs normally to a downstream end of the discharge section despite the fact that the buffer section temporarily stores tubs. For example, the buffer section can be a parallel transportation system to which tubs are fed and then brought to a standstill. In this way, a desired frequency can be realized at a downstream end of the discharge section.

Optionally, the buffer section is designed to lift the at least one tub that is to be temporarily stored against the gravity direction. In other words, the buffer section can lift a tub from the discharge section so that other tubs can pass through the discharge section. This makes it possible to provide a particularly space-saving device, as the buffer section can be arranged above rather than next to the discharge section. The buffer section can have a gripping device for this purpose, which can be designed to lift a tub from the discharge section. Such a gripping device can also be designed to hold more than one tub. For example, it is conceivable that the gripping device can lift one tub at a time while another tub is already being held by the gripping device. This allows the buffer section to be controlled individually in order to achieve a frequency of tubs at the downstream end of the discharge section. The buffer section can, for example, be designed as a rail-like system into which tubs that are to be temporarily stored can be inserted. In this way, a means of transportation of the discharge section can be used to feed the tubs to the buffer section. The rail-like system can be held at the height of the discharge section until the desired number of tubs to be temporarily stored has been inserted. The rail-like system can then be lifted. The rail-like system can be emptied in reverse order. This can provide a largely passive buffer section.

Optionally, the feed section has a first elevator which is designed to convey the tub in a vertical conveying direction. The first elevator can thus be designed to move at least one tub in such a way that it can overcome a vertical height distance (i.e. along or against the gravity direction). The first elevator also offers the advantage that tubs containing nests can be fed from above or below. This means that the removal device can be integrated into a three-dimensional machine layout. Furthermore, the device can be integrated more flexibly into existing machine layouts.

Optionally, the discharge section has a second elevator, which is designed to convey the tub in a vertical conveying direction. The second elevator can be designed identically to the first elevator. The second elevator can transport a tub with or without a nest in a vertical direction (i.e. along or against the gravity direction). The second elevator can be arranged on a downstream side of the discharge section. Further elements can be arranged between the second elevator and the removal device. The second elevator can be used to return a tub (with or without a nest) to a desired height position, for example to be handled by other handling devices.

Optionally, the first elevator and/or the second elevator has a pair of two belts which are designed to convey at least one tub in the vertical conveying direction. The belts can each be arranged circumferentially. In other words, the first elevator and/or the second elevator do not have to be moved in a forward-backward direction, but can be operated in a circulating manner. This increases the throughput so that the entire device can achieve a higher throughput. The belts can be designed in such a way that the tubs interact with the belts in a form-fit and/or force-fit manner. For example, the tubs can have shoulders. The belts can interact with the shoulders in such a way that they contact the tubs at the shoulders. This makes it easy to pick up a tub from the elevator, transport it and put it down again.

Optionally, the pair of belts of an elevator is connected to each other by means of rack portions. In other words, each elevator can have at least two belts. Regardless of how many belts an elevator comprises, the at least one belt can be a chain link belt or a toothed belt. The rack portions, which are optionally rigid, can ensure the synchronization of two belts. This can ensure that a tub being transported by the elevator is not tilted. Furthermore, the rack portions can provide a larger support surface for the tub. Furthermore, the tubs can be pushed out of the elevator or pushed into the elevator. This can be done using a pusher, for example, at an upper tub transfer position. This can reduce the surface pressure on the respective tub.

Optionally, the first elevator and/or the second elevator each has two pairs of belts, which are optionally arranged opposite each other. In other words, each elevator can optionally have 4 circumferential belts. A pair of belts (i.e. two belts) can be provided circulating through a common roller. A further pair of belts may be provided opposite each other, so that an elevator comprises a total of four belts. The belts of a pair of belts can have the rack portions mentioned above. The rack portions of the individual pairs of belts can be arranged so that they run opposite each other. In other words, the belts of the pairs of belts can be controlled in such a way that they can be moved synchronously. This can ensure that a tub that is moved through the elevator is always transported straight (i.e. parallel to the horizontal).

Optionally, the first elevator and/or the second elevator each have only one drive. In other words, each elevator can only have a single drive. This means that no control system is required to provide synchronous operation of the pairs of belts. The power transmission to the belts can be realized by the single drive by mechanical deflection. This means that no active control of drive force distribution to the respective pairs of belts is necessary.

Optionally, the belts of the first elevator and/or the second elevator are arranged to rotate or to revolve. This prevents the belts from moving back and forth. Consequently, a higher throughput of transported tubs can be achieved.

All definitions and embodiments of an elevator given in the description can optionally also apply analogously to the second elevator or to further elevators provided in the device. This applies even if a feature is not explicitly related to the first or second elevator.

Optionally, a conveyor belt is provided for transporting the at least one tub, with the conveyor belt optionally extending in the feed section, the removal section and/or the discharge section. The conveyor belt can, for example, be a link-cell conveyor belt on which the tubs are held in a force-fit and/or form-fit manner. In other words, the tubs can rest on the conveyor belt by their weight and be transported forward by a frictional force between the conveyor belt and the tub. The link-cell conveyor belt has the advantage that it can also define deflections, allowing tubs to be transported and guided in a variety of ways. The conveyor belt can be constantly driven. Furthermore, the conveyor belt can extend in the feed section and the removal section. In other words, the conveyor belt can be designed so that it does not stop in the removal section. This means that the conveyor belt can continue to run under the tub even when a tub is in the removal position. The tub can, optionally, be held in the removal position by the stop while the conveyor belt continues to run under the tub. In this case, a slip occurs in which the speed of the tub, which is in frictional contact with the conveyor belt, deviates from the speed of the conveyor belt. This means that there is no need to implement a complex control system that stops the conveyor belt and restarts it. Instead, it is possible to drive a conveyor belt constantly and to provide it in several areas of the device. This can simplify the control system and increase the handling rate.

Optionally, the conveyor belt has only one drive element. In other words, the conveyor belt can be driven exclusively by a single motor. This is advantageous because no different motor controls are required to drive the conveyor belt synchronously in the different sections.

Optionally, a first sensor is arranged in the removal section, which is designed to output first sensor information, wherein the first sensor information is optionally indicative of whether a nest is present in the tub. The sensor can optionally be an ultrasonic sensor or an optical sensor that can detect by scanning whether a nest is present in a tub. The sensor information can be part of sensor data that the sensor can output. This makes it possible to determine whether a nest is present in the tub and therefore whether it should be removed. If, for example, there is no nest in the tub, the tub can be removed without being brought into the removal position. This means that no empty run or unnecessary movement of the removal device is necessary and time can be saved.

Optionally, a second sensor is arranged in the removal section, which is designed to output second sensor information, wherein the second sensor information optionally are indicative of a position of the tub in the removal section. The first sensor information may differ from the second sensor information. The second sensor can be a sensor that can determine the position of a tub. This can be used to check whether the tub is in the removal position and whether the removal device can remove the nest without any problems. This means that, for example, if the tub is incorrectly positioned, it can be passed on without the need to carry out an unnecessary gripping attempt with the removal device. This can prevent medical vessels from falling out and blocking the machine or causing other damage that would require costly repairs if a gripping attempt fails.

Optionally, the at least one first stopper is designed as a precision stopper. This can ensure that the tub is correctly positioned in the removal position. The precision stopper can, for example, have more than one point of contact with the tub. This can ensure that the tub is not misaligned and that the tub is in the removal position when the stopper is activated. Optionally, the stopper can have two contact sections, each of which can be displaced into the travel path of the tub from an opposite side. Optionally, the two contact points of the precision stopper are arranged opposite each other. The contact points can be designed to stop a tub at an upper tub heel (e.g. at a collar of the tub in which the nest is placed. The tub heel can be located above a tub shoulder. This means that the contact points cannot stop the tub on the underside of the tub. This allows the tub to be stopped precisely in the removal position. Particularly in the embodiment in which the conveyor belt continues to run while the tub is in the removal position, a good hold of the tub is necessary so that a gripping process of the removal device can run efficiently and without errors.

Optionally, the removal section has at least one second stopper, which is optionally arranged upstream of the first stopper. The second stopper may differ from the first stopper. Optionally, the first stopper is designed in such a way that it can prevent a tub from being transported further. However, special positioning of the tub is not a task of the second stopper. Rather, the second stopper should ensure that a tub is made available upstream of the first stopper, which can be fed to the first stopper at short notice. In other words, this can ensure that a tub is always available which can be brought into the removal position. Furthermore, the second stopper can have a greater tolerance in terms of function and/or arrangement than the first stopper.

Optionally, the at least one second stopper can be displaced in the gravity direction from below into a travel path of the tub. In other words, the at least one second stopper can be displaced from below into the travel path. As a result, the second stopper can be controlled with a simple rotary movement and prevent a tub from being transported further. Furthermore, while a tub is held by the at least one second stopper, a conveyor belt on which the tub rests can continue to be operated. This means that in this case, too, it is not necessary to stop the conveyor belt in order to prevent a tub from being transported further.

Optionally, the first stopper is displaced transversely to the gravity direction, in a travel path of the tub. This allows the at least one first stopper to engage a collar of the tub, whereby the tub can be positioned accurately. In other words, the rest of the design of the tub can be irrelevant for correct positioning, and only the collar can be used to assume the removal position. This is particularly necessary as there are different shaped tubs, which may have a different body depending on the medical vessels to be transported. However, the collar is a reference point for all tubs. This ensures that the removal position can be optimally assumed by the tub by actuating the first stopper. Optionally, the discharge section has at least one third stopper, which is arranged downstream of the removal position. In this way, the at least one third stopper can be used to retain a tub again downstream of the removal device and prevent it from being transported further. This is particularly advantageous if a certain frequency is required at the exit of the device. Furthermore, this can be advantageous if a buffer section is provided that separates tabs from the stream and stores them temporarily. The separation process can be realized, for example, by a lifting device or a switch device that briefly blocks the flow of tubs. This makes it advantageous if a tub is briefly held back upstream of such a buffer section until further transportation past the buffer section is possible without any problems.

Optionally, the removal section has at least one guide element that is designed to limit a transport path of the tub. The at least one guide element can, for example, be a guardrail-like structure that guides the at least one tub to be transported. In other words, the tub can be supported and moved from below by the conveyor belt, whereas lateral movement of the tub is prevented by the at least one guide element. Furthermore, the at least one guide element can interact with one of the stoppers in such a way that lateral deviation of the tub is prevented even in the event of a stop (for example by the at least one first stopper). This can further ensure that the tub can be arranged correctly in the removal position.

Optionally, the discharge section has a deflection to change the conveying direction of the tub. Optionally, the deflection is designed in such a way that a transport direction of a tub is changed by at least 90°. This makes it possible to achieve a particularly compact device, as little space is required for transportation. This function can be achieved by means of a tub transfer.

According to a further aspect of the present disclosure, a nest handling system for handling a tub and a nest is provided. The nest handling system may comprise a nest removal device according to one of the above embodiments for removing a nest from a tub. Further, the nest handling system may comprise a nest insertion device for inserting a nest into a tub, wherein the nest insertion device is arranged in the discharge section. The nest insertion device may comprise an insertion section designed to position the at least one tub in an insertion position. Furthermore, the nest insertion device may comprise an insertion device designed to insert the nest into a tub that is in the insertion position.

The nest handling system offers the advantage that a nest removal device can be combined with a nest insertion device. This offers the possibility that nests, which have previously been removed from a tub together with medical vessels, can later be fed back into a tub without the medical vessels. This can provide holistic handling of tubs with nests. For example, while the nest is removed from the tub and transported away in a conveyor belt as described above, the vessels can be removed from the nest so that the nest is without vessels. The empty nest can then be reinserted into a tub using the nest insertion device.

Optionally, the nest insertion device is arranged downstream of the buffer section. The buffer section can, for example, be designed to make the empty tubs available to the nest insertion device in such a way that the nests can be efficiently inserted into the tubs provided. This can be particularly advantageous when the system is starting up, as more empty tubs may be available than there are empty nests to be reintroduced. This allows the buffer section to temporarily store the surplus tubs so that the machine can still operate without problems and without interruption.

Optionally, the nest insertion device is arranged upstream of the second elevator. In other words, a tub into which a nest has been inserted by the nest insertion device can be transported away together with the nest in a vertical direction. This means that the machine can be integrated into existing lines in a variety of ways, as vertical feeding and removal is also possible.

Optionally, the nest removal device and the nest insertion device are connected to each other in such a way that the nests removed by the nest removal device can be fed back to the tubs of the nest insertion device. In other words, this can be a machine in which no tubs are discharged without a nest. In other words, the nests can be removed from the tubs and then all the tubs can be provided with nests again. This eliminates the need for further handling by other machines or a manual user and can increase efficiency.

Optionally, the nest removal devices and the nest insertion device are designed so that a tub passes through both the nest removal device and the nest insertion device.

According to a further aspect of the present disclosure, a method for handling a nest and a tub is provided. The method may comprise feeding at least one tub in which a nest is received, wherein the tub is Optionally fed in a conveying direction. Furthermore, the method may comprise positioning the at least one tub in a removal position. Furthermore, the method can comprise removing the nest from the tub, which is in the removal position. Furthermore, the method may comprise removing the tub. Optionally, the positioning of the tub is performed with a first stopper to position the tub in the removal position.

Individual features or embodiments can be. be combined with other features or other embodiments to form new embodiments. Further developments and advantages mentioned in connection with the features or embodiments also apply analogously to the new embodiments. Further developments and advantages mentioned in connection with the device also apply to the method and vice versa.

### BRIEF DESCRIPTION OF THE DRAWINGS

In the following, the subject matter of the present disclosure is described in detail with reference to the attached figures.

FIG. 1 shows a schematic and perspective view of a tub with a nest;

FIG. 2 is a schematic and perspective view of a part of a nest removal device according to an embodiment of the present disclosure;

FIG. 3 is a schematic and perspective view of a part of the nest removal device according to an embodiment of the present disclosure;

FIG. 4 is a schematic and perspective view of a part of a removal device according to an embodiment of the present disclosure;

FIG. 5 is a perspective and schematic view of a part of a removal device according to an embodiment of the present disclosure;

FIG. 6 is a perspective and schematic view of a part of a removal device according to an embodiment of the present disclosure;

FIG. 7 is a perspective and schematic view of a part of a removal device according to an embodiment of the present disclosure;

FIG. 8 is a perspective and schematic view of a part of a removal device according to an embodiment of the present disclosure;

FIG. 9 is a top view of a nest handling system according to an embodiment of the present disclosure; and

FIG. 10 is a schematic flow chart of a method according to an embodiment of the present disclosure.

### DETAILED DESCRIPTION OF THE PREFERRED EMBODIMENTS

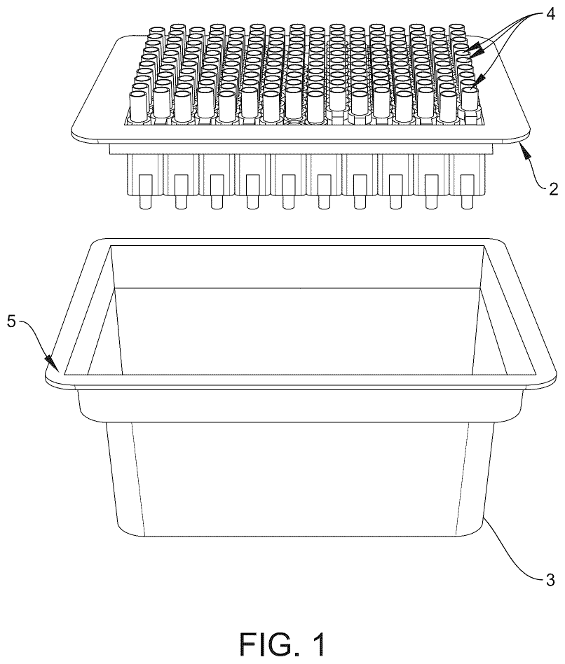

FIG. 1 is a schematic and perspective view of a tub 3 with a nest 2. The tub 3 and the nest 3 are designed so that the nest can be removably arranged in the tub 3. The nest 2 has a plurality of receiving sections, in each of which a vessel 4 can be arranged. The vessels 4, which are arranged in the nest 2, do not contact the tub 3 when the nest 2 is arranged in the tub 3. The nest therefore enables a large number of vessels 4 to be transported without each individual vessel having to be handled. The tub 3 has a tub-like design with a surrounding collar 5. The collar 5 is designed in such a way that the tub 3 can be handled with the collar 5.

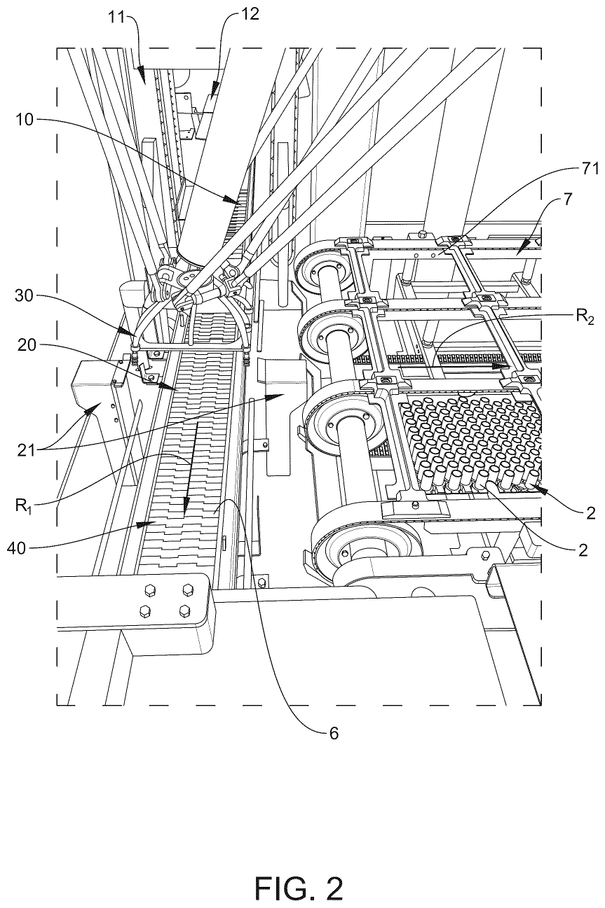

FIG. 2 is a schematic and perspective view of a part of the nest removal device 1 according to an embodiment of the present disclosure. More precisely, FIG. 2 shows a view against the transport direction R1 through which a tub 3 passes during operation of the nest removal device 1. In FIG. 2, a conveyor belt 6 can be seen, which is driven in the transport direction R1. The tubs 3 can be placed on the conveyor belt 6 so that the tub 3 is transported in the transport direction R1. The tubs that are fed to the nest removal device 1 are first transported on a feed section 10. In the present embodiment, the feed section 10 has a first elevator 11. In other words, the tubs 3 can be fed to the conveyor belt 6 by the first elevator 11 from a level vertically above the conveyor belt 6. It is also possible to feed tubs 3 in the plane of the conveyor belt 6. This can be seen in the background in FIG. 2, where a manual feed 12 is shown. This allows a tub 3 to be fed to the nest removal device via several feed paths. The tub is then fed to a removal section 20. In the removal section 20, the tub 3 is positioned in the removal position. Positioning is performed by a first stopper 21. In the present embodiment, the first stopper 21 is a precision stopper that can position the tub 3 so that it is securely arranged in the removal position. When the tub 3 is in the removal position, a removal device 30 can be actuated so that the nest 2 can be lifted out of the tub 3. The removal device 30 is designed in such a way that it can feed a removed nest 2 to a further conveyor belt 7. In the present embodiment, the conveyor belt 7 has receiving sections in each of which a nest 2 can be received. In the present embodiment, the transport device 7 has three receiving sections next to each other transversely to the second conveying direction R2. The removal device 30 is positioned in an initial position such that it is arranged adjacent to the middle receiving section of the transport device 7. This ensures that the removal device has the minimum travel distance to move from the removal position to one of the three receiving sections of the transport device. Once the nest 2 has been removed from the tub 3, the now empty tub 3 is transported away by a discharge section 40. In the present embodiment, the conveyor belt is arranged continuously through the feed section 10, the removal section 20 and the discharge section 40. This means that only a single conveyor belt 6 is required for the respective sections. The conveyor belt is constantly driven and therefore does not stop. The tub is held in the removal position by the first stopper 21, while the conveyor belt 6 continues to move under the tub.

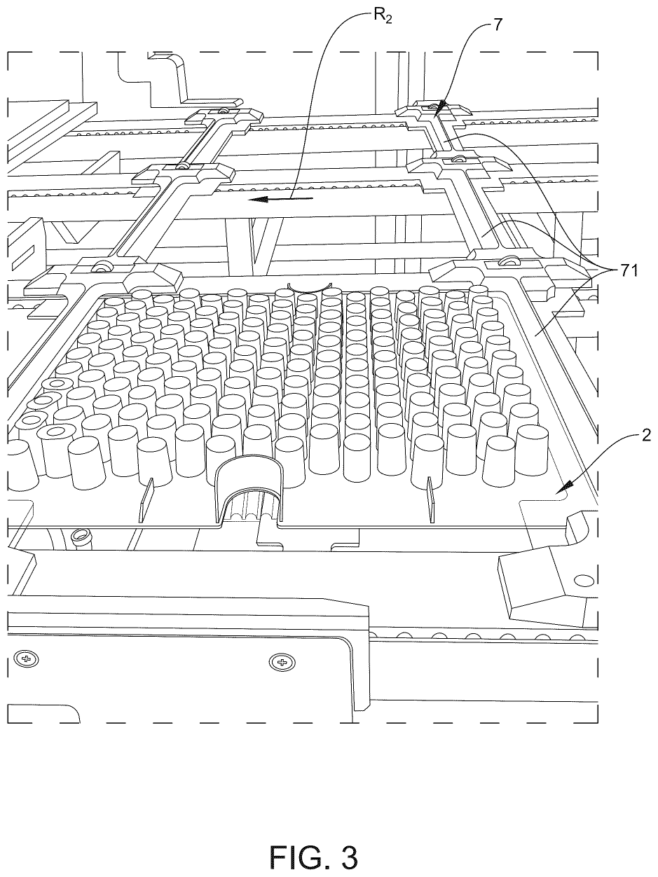

FIG. 3 is a schematic and perspective view of the transport device 7 according to one embodiment of the present disclosure. As shown in FIG. 3, the transport device 7 has several receiving sections 71 in the second transport direction R2. In the present embodiment, three receiving sections 71 are arranged next to one another transversely to the transport direction R2. The transport sections 71 are each arranged in such a way that they can hold a nest 2 without damaging the vessels 4 in the nest. The transport device 7 is provided as a circulating transport device so that no back and forth movement is necessary. This can increase the throughput.

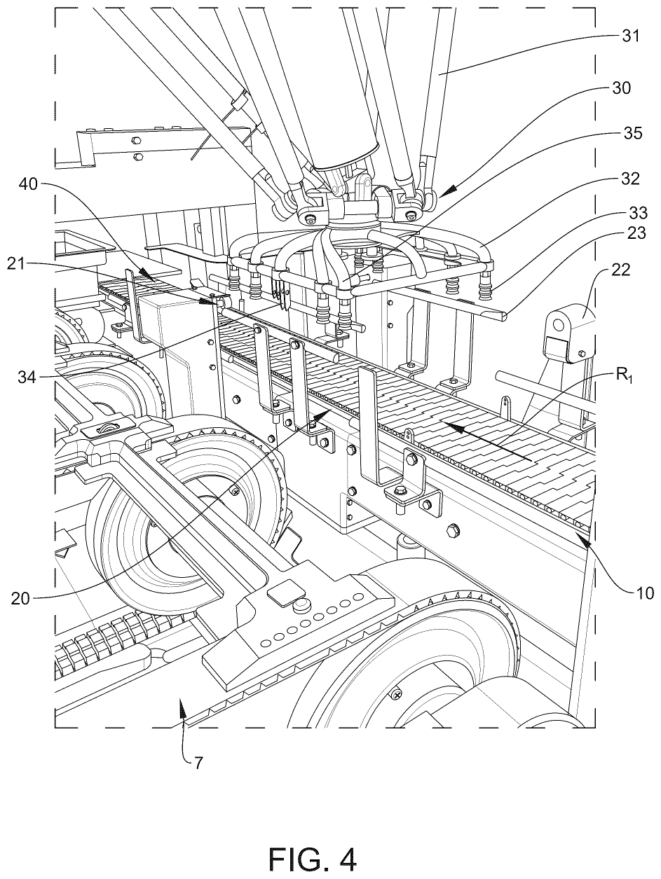

FIG. 4 is a schematic and perspective view of a part of the removal device 1 according to an embodiment of the present disclosure. In FIG. 4 it can be seen that the removal section 20 has a first sensor 22, which can output first sensor information. The first sensor information is indicative of whether a tub 2 is received in a nest 3. Furthermore, the removal section has at least one guide element 23, which can limit a transport path of a tub 3. The removal device 30 has a moving section 31 and a gripping section 32. In the present embodiment, the moving section 31 is designed as a so-called delta robot. This allows the removal device to move to any position in the room. The gripping device 32 is designed as a suction gripper. In the present embodiment, the suction gripper has 8 individual suction heads. The suction heads 33 are provided on the gripping device 32 in such a way that they correspond to a contact section of a nest 2. This ensures that the removal device 30 can easily remove a nest 2 from a tub 3. For more reliable positioning of the gripping device 32, the gripping device 32 of the present embodiment has a projection 34. The projection 34 extends in the same direction from the gripping device 32 as the suction heads 33. The projection 34 thus acts as a centering aid which, upon contact with a nest 2, ensures that minor positional deviations between the gripping device 32 and the nest are rectified. To this end, the projection 34 can have a tapered shape.

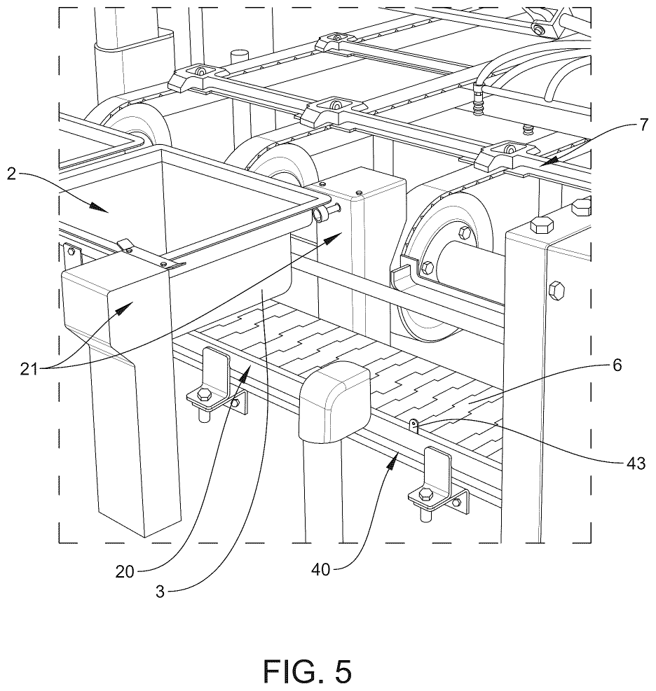

FIG. 5 is a schematic and perspective view of a part of the removal device 1 according to an embodiment of the present disclosure. In FIG. 5, a tub 3 is shown which is in the removal position. In other words, in the situation shown in FIG. 5, the conveyor belt 6 continues to be driven and the tub 3 is held in the removal position by the first stopper 21. In a next step, the removal device 30 removes the nest 2, which is held in the tub 3, and feeds it to the conveyor device 7. After the nest 2 has been removed from the tub 3, the first stopper 21 will retract so that the tub 3 is transported further by the conveyor belt 6 into the discharge section 40. The discharge section 40 has a further stopper 43 that can stop the tub after it has left the removal position. This allows the removal of tubs 3 to be controlled in a targeted manner.

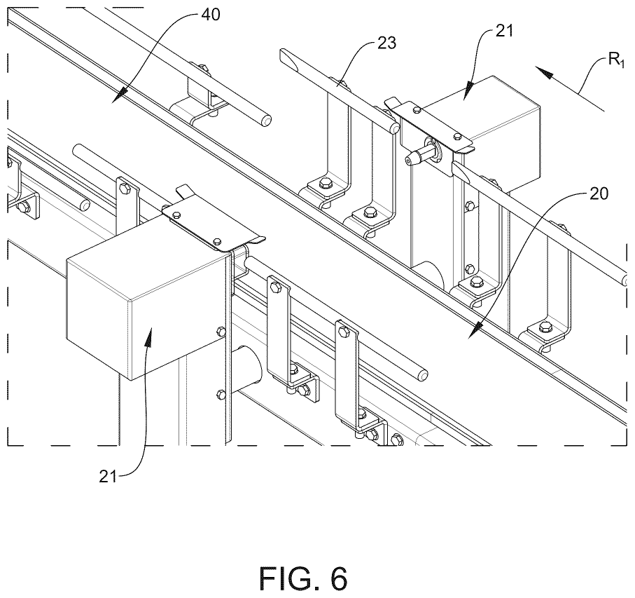

FIG. 6 is a schematic and perspective view of the removal section 20 according to one embodiment of the present disclosure. In FIG. 6 it can be seen that the first stopper 21 is a precision stopper, which is arranged on both sides transversely to the first conveying direction R1. Furthermore, several guide elements 23 are recognizable, which limit the transport path of a tub.

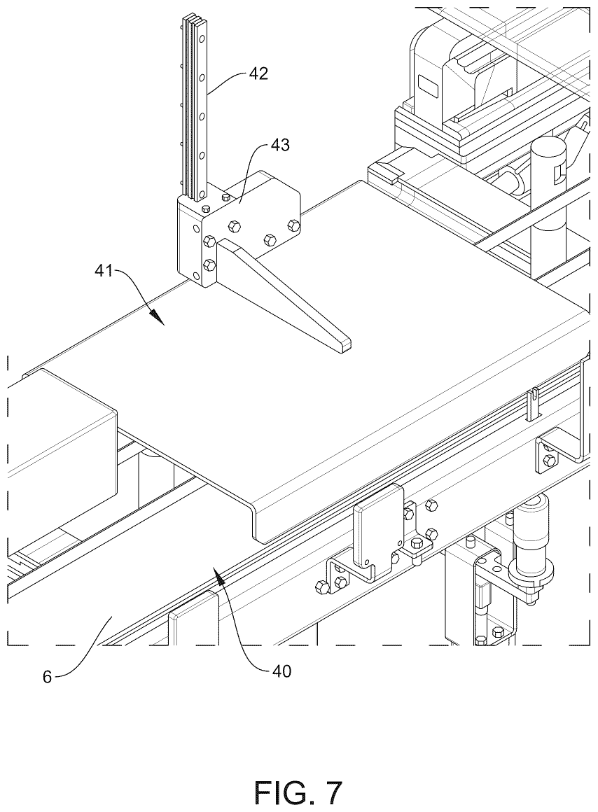

FIG. 7 is a schematic and perspective view of a discharge section 40 according to an embodiment of the present disclosure. More specifically, a buffer section 41 is shown in FIG. 7. The buffer section 41 is designed to temporarily store at least one tub 3. In the present embodiment, buffering means that a tub 3 is lifted from the conveyor belt 6 and temporarily stored in the buffer section 41. This allows the frequency and number of tubs 3 to be forwarded to be controlled. The buffer section 41 of the present embodiment is designed to lift at least one tub 3 vertically so that further tubs 3 can pass through the buffer section 41 on the conveyor belt 6 as long as a tub is temporarily stored in the buffer section 41. The buffer section 41 functions with a threaded spindle 42 and a gear wheel drive 44.

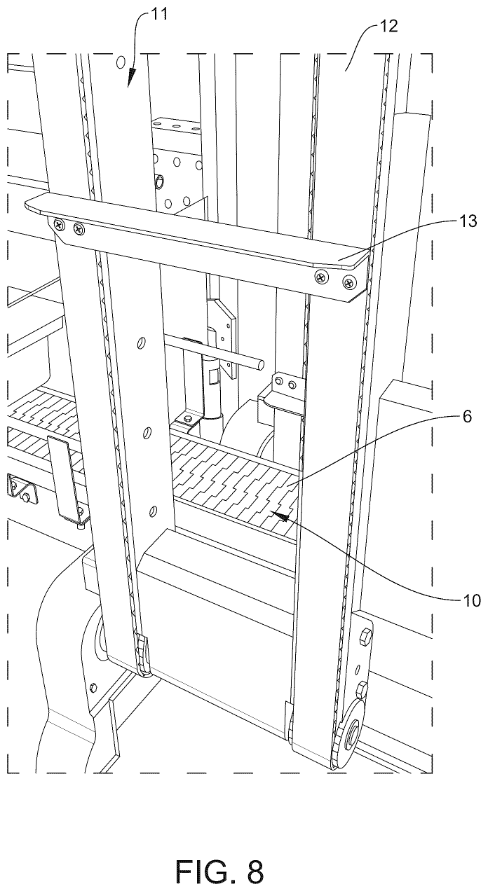

FIG. 8 is a perspective and schematic view of an elevator according to an embodiment of the present disclosure. It should be noted that in one embodiment of the present disclosure, a first elevator 11 and a second elevator 42 are provided. Both elevators 11, 42 may be identically designed. In other words, both elevators may have the same or at least partially the same features. In the following, the first elevator 11 shown in FIG. 8 will be discussed, but the same description also applies to the second elevator 42. The first elevator 11 has a total of 4 belts 12. The 4 belts 12 are distributed over 2 pairs of belts. A pair of belts means that two belts are driven in rotation via a shaft. The two pairs of belts are arranged opposite each other so that they accommodate the conveyor belt 6 between them. The belts 12 are arranged to rotate so that no back and forth movement is necessary. The two belts of a pair of belts are connected by a rack portion 13. The rack portion 13 can also be referred to as a support section. The rack portion 13 is designed to correspond to a collar 5 of a tub 3. Because the two pairs of belts are arranged opposite each other, two rack portions 13 can each move a tub 3 in the vertical direction. The elevator 11 also only has a single drive element, which drives both pairs of belts via a mechanical gear connection. This ensures that the pairs of belts run synchronously.

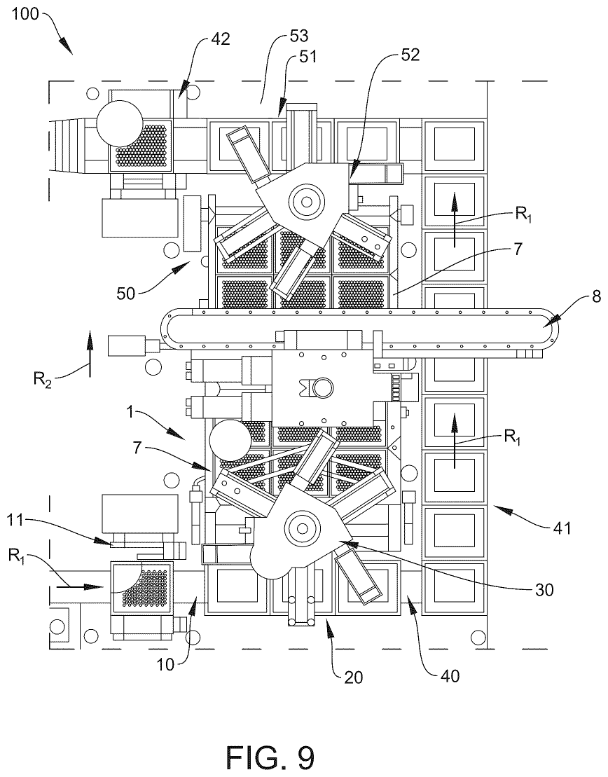

FIG. 9 is a schematic top view of a nest handling system 100 according to one embodiment of the present disclosure. In the lower part of FIG. 9, the nest removal device 1 according to one of the above embodiments is shown. In the upper part of FIG. 9, a nest insertion device 50 is shown. The transport device 7 extends between the nest removal device 1 and the nest insertion device 50. The nests 2 are thus removed from the tubs 3 by the nest removal device 1 and fed to the transport device 7. The nests 2 are then transported by the transport device 7 in the second transport direction R2 to the nest insertion device 50. In this way, a further device can remove eight vessels 4 from the nests 2 and transport them away. In other words, only empty nests 2 can be fed to the nest insertion device. After the removal section 20, the empty tubs are also transported to the nest insertion device 50 by the removal section 40. The nest insertion device 50 has an insertion section 51. The insertion section 51 in turn has a nest insertion device stopper 53, which can position an empty nest 3 in such a way that an insertion device 52 can remove the nest from the transport device 7 and feed it to the empty tub, which is held by the stopper 53. The stopper 53 can then stop holding the nest so that the nest can be transported further away. In one embodiment, the tub 3 with the empty nest is fed to a second elevator 42, which can transport the tub 3 away in a vertical direction.

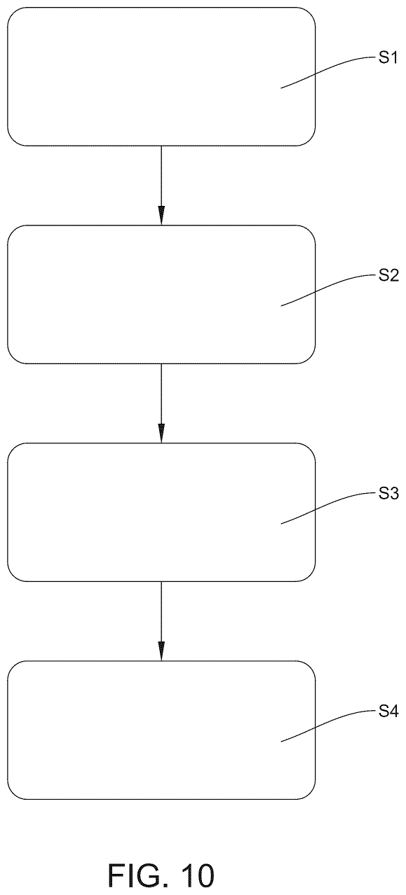

FIG. 10 is a schematic flow chart of a method according to one embodiment of the present disclosure. In step S1, at least one tub is fed, wherein a nest is accommodated in the tub. The feed takes place in the conveying direction R1. In a step S2, the at least one tub is positioned in a removal position. The removal position is defined by a first stopper 21. In a further step S3, the nest is removed from the tub 3 by a removal device 38. The empty tub is discharged in a step S4. Precise positioning of the tub can be realized by the first stopper.

### LIST OF REFERENCE SIGNS

1 Nest removal device
2 Nest
3 Tub
4 Vessel
5 Collar
6 Conveyor belt
7 Transport device
8 Further device
10 Feed section
11 First elevator
12 Belts
20 Removal section
21 First stopper
22 First sensor
23 Guide element
30 Removal device
31 Moving section
32 Gripping device
33 Suction head
34 Projection
35 Vacuum line
40 Discharge section
41 Buffer section
42 Tooth splint or toothed rack
43 Further stopper
44 Gearwheel device
50 Nest insertion device
51 Insertion section
52 Insertion device
53 Nest insertion device stopper
100 Nest handling system
R1 First direction or conveying direction
R2 Second direction

1. A nest removal device for removing a nest from a tub, comprising:
a feed section configured to convey at least one tub, in which the nest is accommodated, in a conveying direction;
a removal section configured to position the at least one tub in a removal position;
a removal device configured to remove the nest from the at least one tub, which is in the removal position; and
a discharge section configured to transport the tub away;
wherein the removal section comprises at least a first stopper for positioning the tub in the removal position.

2. The nest removal device according to claim 1, wherein the discharge section has a buffer section configured to temporarily store at least one tub.

3. The nest removal device according to claim 2, wherein the buffer section is configured to temporarily store an empty tub.

4. The nest removal device according to claim 3, wherein the buffer section is configured to lift the at least one tub to be temporarily stored against the gravity direction.

5. The nest removal device according to claim 4, wherein the discharge section is configured to discharge empty tubs from the nest removal device.

6. The nest removal device according to claim 1, wherein the feed section comprises a first elevator configured to convey the that at least one tub in a vertical conveying direction.

7. The nest removal device according to claim 1, wherein the first elevator comprises a pair of two belts configured to convey at least one tub in the vertical conveying direction

8. The nest removal device according to claim 1, wherein a conveyor belt is provided for transporting the at least one tub, wherein the conveyor belt extends in the feed section, the removal section and/or the discharge section.

9. The nest removal device according to claim 1, wherein a first sensor is arranged in the removal section configured to output a first sensor information, wherein the first sensor information is indicative of whether a nest is present in the at least one tub.

10. The nest removal device according to claim 1, wherein a second sensor is arranged in the removal section configured to output a second sensor information.

11. The nest removal device according to claim 1, wherein the removal section comprises at least a second stopper arranged upstream of the first stopper.

12. The nest removal device according to claim 1, wherein the discharge section comprises at least a third stopper arranged downstream of the removal position.

13. The nest handling system for handling the tub and the nest, comprising:
the nest removal device according to claim 1 for removing the nest from the at least one tub; and
a nest insertion device for inserting the nest into the at least one tub, wherein the nest insertion device is arranged in the discharge section;
wherein the nest insertion device comprises:
an insertion section configured to position the at least one tub in an insertion position; and
an insertion device configured to insert the nest into a tub of the at least one tub which is in the insertion position.

14. The nest handling system according to claim 13, wherein the nest removal device and the nest insertion device are connected to each other such that the nests removed by the nest removal device can be fed back to the tubs of the nest insertion device.

15. The method of handling a nest and a tub, comprising:
conveying at least one tub, in which a nest is accommodated, in a conveying direction;
positioning the at least one tub in a removal position; and
removing the nest from the at least one tub, which is in the removal position, and discharging the at least one tub;
wherein the positioning is performed with a first stopper to position the at least one tub in the removal position.

16. The nest removal device according to claim 7, where the belts are arranged circumferentially.

17. The nest removal device according to claim 10, wherein the second sensor information is optionally indicative of a position of the tub in the removal section.

18. The nest removal device according to claim 1, wherein the buffer section is configured to temporarily store an empty tub.

19. The nest removal device according to claim 1, wherein the buffer section is configured to lift the at least one tub to be temporarily stored against the gravity direction.

20. The nest removal device according to claim 1, wherein the discharge section is configured to discharge empty tubs from the nest removal device.
